(19) United States
(12) Patent Application Publication
(10) Pub. No.: US 2003/0000163 A1
(43) Pub. Date: Jan. 2, 2003

(54) Doorlite system

(75) Inventor: Rocco Lamanna, Woodbridge (CA)

Correspondence Address: Douglas S. Johnson, Ste 301, 133 Richmond Street West, Toronto, ON, M5H 2L7, CA

(73) Assignee: Royal Group Technologies Limited

(21) Appl. No.: 09/895,397

(22) Filed: Jul. 2, 2001

(30) Foreign Application Priority Data
Jun. 30, 2001 (CA) 2,313,325

(51) Int. Cl. E06B 3/964

(52) U.S. Cl. 52/204.62

(57) ABSTRACT

A doorlite system in which a doorlite is mounted in an opening in a door by means of an outer frame and an inner frame adapted to be screwed together, the outer frame has a body portion for insertion into the door opening from the outer side of the door, a flange for engaging the door around the perimeter of the opening and a flange for engaging the glazing unit or doorlite. Similarly, the inner frame has a body portion for insertion into the door opening from the inner side of the door and has a flange to engage the door around the perimeter of the opening and a flange for engaging the doorlite. The bodies of these frames having interengaging registering means extending continuously therearound. Further, the inner frame has a groove on its exterior side to house the heads of the securing screws and a snap on frame is provided to cover the screw heads. The invention also contemplates a divided doorlite in which two glazing members are separated by outer and inner muntin bars adapted to be screwed together to engage and support the contiguous edges of the glazing members.

### FIELD OF THE INVENTION

This invention relates to the art of mounting glass or other light transmitting panels in door openings, such mounted panels being known in the art as doorlites. More particularly, the invention relates to a novel doorlite mounting system, the doorlite supporting frames of the system, their manufacture and their packaging.

Again, more particularly, the invention relates to the provision of a novel doorlite mounting system which enables doorlites to be accurately installed in an extremely simple operation including the installation of actual or truly divided doorlites with the resulting installation being decorative and free of any visible fasteners thus enhancing the aesthetics of the door in addition to providing the desired doorlite feature.

In this connection, the invention is particularly directed to a mounting system which provides for the quick, simple and accurate mounting of a doorlite including separate light transmitting panels by means of screws whose heads are fully concealed.

### BACKGROUND OF THE INVENTION

In order to support a light transmitting panel, which is usually glass, in an opening provided in a door, a frame arrangement must be provided to support the glass panel and this frame must be made to fit in the door opening and secured in place by framing members secured to opposite sides of the door by screws or other fasteners whose visible presence detracts from the appearance of the doorlite.

To avoid the additional work and complexity of having separate glass panels for divided doorlites, it is conventional to simply use wood or other struts or bars bridging a simple glass panel to give the appearance of a divided doorlite. Such dividing bars simply add to the work required to provide a finished appearance to the divided doorlites.

The present invention is directed to providing a doorlite system which enables doorlites, including truly divided doorlites, to be accurately installed in an extremely simple operation with all securing fasteners fully concealed so that the resulting installation enhances the aesthetics of the door in addition to providing the desired doorlite feature.

### SUMMARY OF THE INVENTION

The invention involves the provision of an inner frame and an outer frame to be inserted from the inner and outer sides of a door respectively into an opening provided in the door and then screwed together to embrace the door around the perimeter of the door opening and to support the doorlite therebetween within the door opening. To provide for the hiding of the heads of the screws used to secure the frames together, the inner frame has a channel formation therein to house the heads of the screws. A cover member for the channel is then provided to overlie and conceal these screw heads.

For the divided doorlite, inner and outer muntins are provided for bridging across the door opening these muntins being adapted to be screwed together to support a doorlite glass or panel at opposite sides thereof. Again, to provide for the optimum aesthetics of the doorlite, the inner muntin is provided with a channel therein to house the heads of screws used to secure the muntins together and a cover is provided for the channel to hide the screw heads.

Again, according to another aspect of the invention, the inner and outer frames have interengaging registering formations extending therearound.

In another aspect, the invention involves the novel manufacture and packaging of such frames ready for insertion into openings provided in doors in which the openings have straight sides.

In this connection, lengths of material having the profiles of the inner and outer frames and the inner frame screw head cover corresponding to the length of the perimeter of the opening in the door into which the doorlite is to be mounted are extruded and drilled to provide the requisite screw guiding bores.

The frames are then screwed together with the screw heads housed in the channel in the inner frame profile and the cover snapped in place to close the channel. These screwed together inner and outer frame profiles with the channel cover in place are then cut into lengths corresponding to the lengths of the sides of the doorlite opening and at the required angles so that the cut lengths can be assembled into a frame to fit the door opening.

In the case of a rectangular opening in the door, the assembled lengths of screwed together frame profiles and cover member are cut at 45 degree angles at the appropriate points to form the four sides of the ultimate desired frame with each side having 45 degree ends. These sides are then assembled into the rectangular frame and screwed together ready for shipping.

At the cite of the doorlite installation, the screws holding the inner and outer frames together are temporarily removed, the body of the outer frame is inserted into the door opening from the outer side of the door, the glass placed within the outer and inner frames, and the body of the inner frame inserted into the door opening from the inner side of the door. The frames are then screwed back together and the screw head cover snapped in place to complete the installation.

In the case of the divided doorlite, the inner and outer frames will be assembled as set out above with two glass panels located therebetween and held separated by the inner and outer muntins which are bridged across the assembled inner and outer frames. After screwing the muntins together, the muntin screw head housing channel will be closed by the snap cover as in the case of the inner and outer frames.

It will thus be appreciated that after receiving the packaged assembled doorlite frame unit, the customer need only remove the snap covers, remove the screws, assemble the doorlite, unit in the door opening with the appropriate glass sections, screw the inner and outer frames and muntins together and close the screw head channels with the snap on covers.

These and other features and advantages of the invention will become apparent from the following detailed description taken in conjunction with the accompanying drawings.

### BRIEF DESCRIPTION OF THE DRAWINGS

FIG. 1 is an exploded perspective view of a doorlite assembly embodying the invention;

FIG. 2 is an end elevational view showing the profiles of the inner and outer frame extrusions and showing the frame members secured together by screws whose heads are housed in the inner frame channel which is closed by a snap cover;

FIG. 3 is a view similar to FIG. 2 but with the inner and outer frame profiles modified to support a wider doorlite panel;

FIG. 4 is a broken away perspective view illustrating the inner and outer muntin bars being assembled to support the glazing panels on each side thereof to provide a doorlite;

FIG. 5 is an end view showing the profiles of the inner and outer muntin bars and the cover for closing the channel of the inner muntin bar;

FIG. 6 shows the muntin bars assembled and secured in position showing one of the screws with its head housed in the channel in the inner muntin bar which is closed with the snap lock cover.

### DETAILED DESCRIPTION ACCORDING TO THE PREFERRED EMBODIMENTS OF THE PRESENT INVENTION

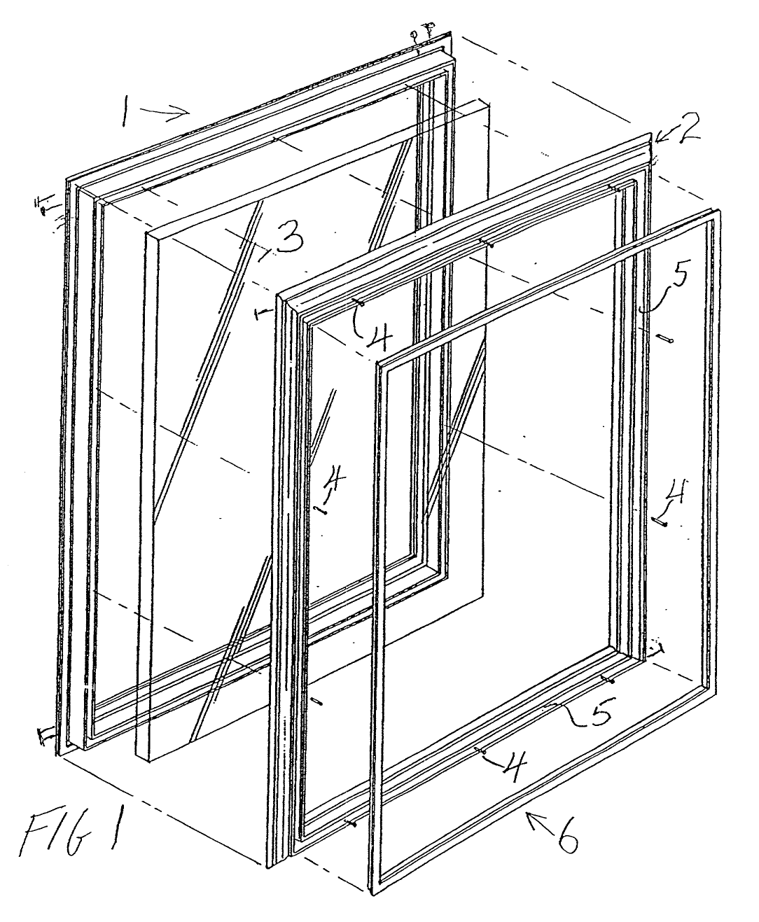

With reference to FIG. 1, the doorlite panel system of the invention is shown as comprising an outer frame generally designated at 1, an inner frame generally designated at 2 the body portions of which are adapted to be inserted in an opening in a door from the outer and inner sides thereof to secure a glass or other light transmitting panel 3 therebetween. The frames 1 and 2 after insertion into the door opening from opposite sides thereof are secured together by screws 4 which are screwed in through a channel 5 provided at the rear of the inner frame 2 and extending around the perimeter thereof.

After screwing the frames 1 and 2 together, a closure frame 6 which snap fits with the channel 5 covers the heads of the screws housed in the channel.

FIG. 2 shows the cross sectional profile of each of the sides of the outer frame 1 and the inner frame 2.

Considering first the outer frame, it comprises a body portion 7 having an outer wall 8 and an inner wall 9 spaced from the wall 8. The outer wall 8 extends beyond the inner wall 9 at the exterior side of the frame and terminates in a door engaging flange 10 The inner wall 9 terminates in an inwardly extending glazing unit engaging flange 11.

Joining the exterior end of the outer wall 8 and the end of the flange 11 is a trim wall 12.

The outer frame body 7 at its interior side is provided with a socket 13 for a purpose which will hereinafter appear.

The profile of each side of the inner frame 2 as shown in FIG. 2 has a body portion 14 having an outer wall 15 and an inner wall 16 which define a channel 17 therebetween having locking ribs 18 at the entrance thereto. The outer wall 15 at its exterior side terminates in an outwardly extending door engaging flange 19.

The inner wall 16 at the interior side of the body portion ends in an inwardly projecting glazing unit engaging flange 20. A trim wall 21 extends between the exterior end of the inner wall 16 to the inner end of the flange 20.

At its interior side, the body portion 14 of the inner frame has an interiorly projecting nose 22 which is adapted to be snugly received in the socket 13 at the interior end of the body portion 7 of the outer frame 1.

It will be understood that the body portion 7 of the outer frame 1 will be introduced from the exterior of the door D into a doorlite opening 23 provided in the door as shown in dotted lines in FIG. 2.

The inner frame 2 will then have its body portion 14 inserted into the doorlite opening 23 from the interior of the door. By providing the socket 13 at the inner side of the outer frame body 7 and the projecting nose 22 at the inner side of the body portion 14, the inner frame 2, the entering of the nose 22 into the socket 13 provides accurate registration of the frames 1 and 2 which extends continuous around the perimeters of the frame bodies 7 and 14.

These two registered frames are then secured together by screws 4 which are introduced into the channel 17 in the inner frame to extend through the nose 22 of the inner frame and into the body portion 7 of the outer frame with the heads of the screws, only one of which is shown at 24 housed in the channel 17.

It will be understood that to facilitate the securing of the inner and outer frames together appropriately spaced screw guiding holes will be drilled through the interior of the inner frame and into the interior of the outer frame.

Following the screwing of the inner and outer frames together, the channel 17 in which the screw heads are housed is closed by the closure frame 6 which has spaced legs 25 flared at their inner ends to snap beneath the locking ribs 18 provided at the mouth of the channel 17 thereby concealing the screws.

Typically, the doorlite or glazing member 3 shown in dotted lines in FIG. 2 might comprise a glass panel having a ¾ inch thickness. However, for example, the doorlite system of the present invention could be used to support a doorlite in the form of a wider sealed glass unit having a thickness of 13/16ths of an inch which features a built in Venetian blind.

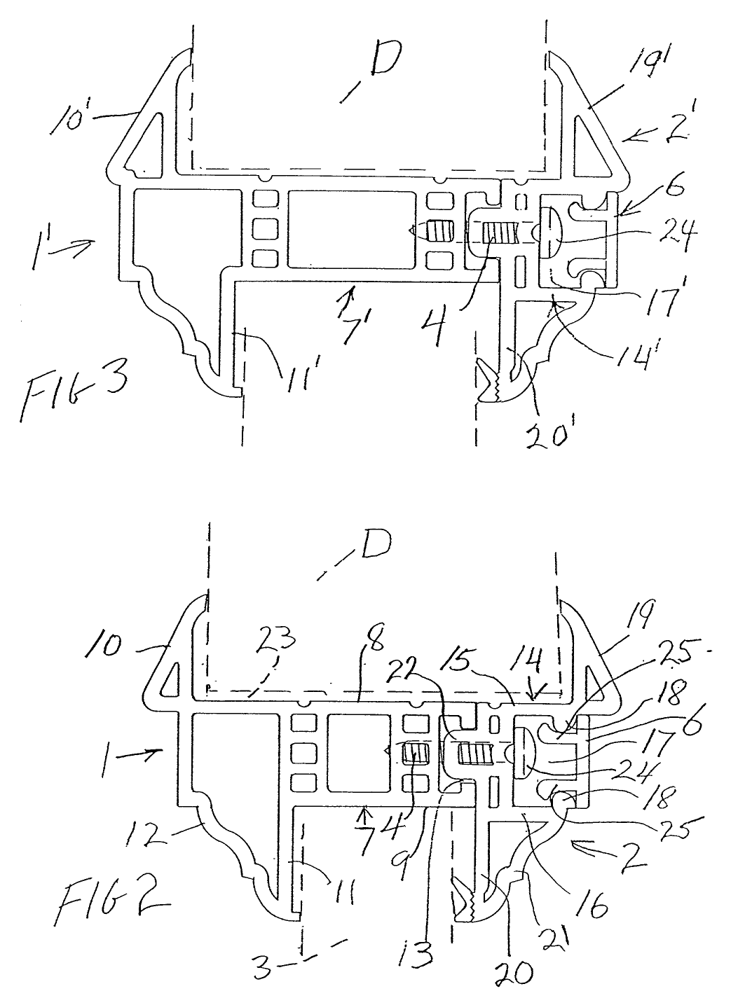

FIG. 3 shows the frame assembly for supporting such a wider doorlite 27 in the opening 23 provided in a Door.

Again, the doorlite system of FIG. 3 comprises an outer frame 1′ which corresponds to the outer frame 1 but has a body 7′ which is longer than the body 7 of the outer frame 1.

The inner frame 2′ corresponds to the inner frame 2. These frames 1′ and 2′ fit together in precisely the same way as the frames 1 and 2 as shown in FIG. 2 and are secured together by screws 4 with their heads housed in the channel 17′ provided in the inner frame 2′ with the channel being closed by the closure frame 6.

As before, the body portion 7′ of the outer frame carries the door engaging or embracing flange 10′ and the glazing unit engaging or embracing flange 11 ′ while the body portion 14′ of the inner frame 2′ carries the door engaging flange 19′ and the doorlite glazing unit flange 20′.

FIG. 4 shows the provision of a divided doorlite in which there is provided an upper glass or light transmitting panel 28 and a lower glass or light transmitting panel 29 divided by a muntin bar arrangement generally designated at 30.

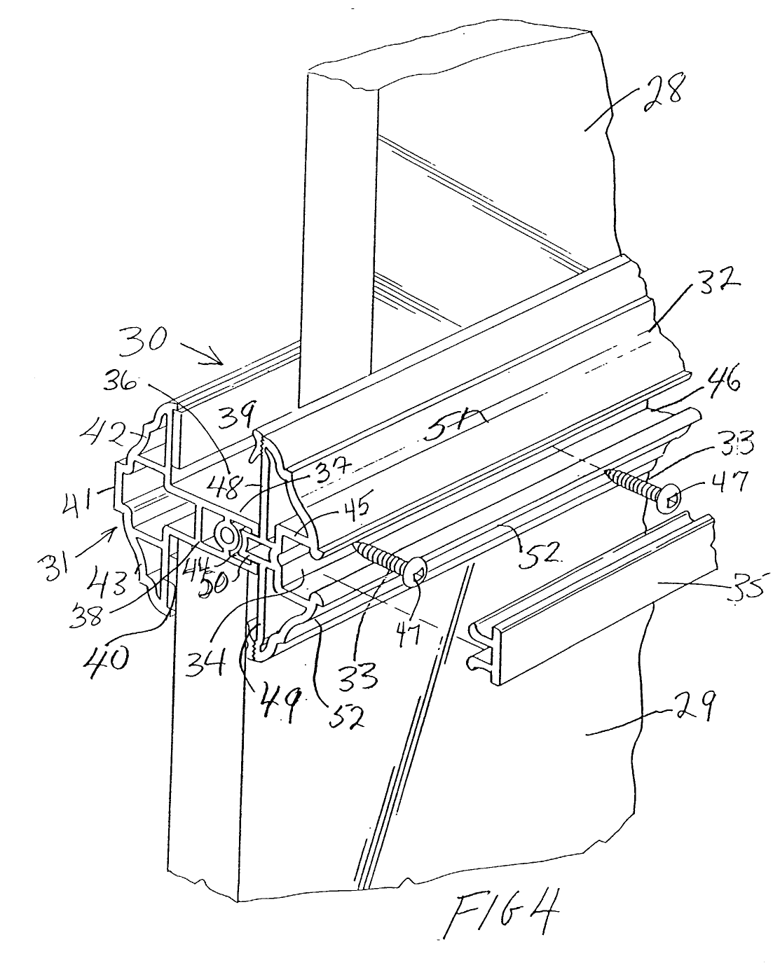

This muntin bar arrangement comprises an outer muntin bar 31 and an inner muntin bar 32 adapted to be secured together by screws 33 which are introduced into a channel 34 provided in the inner muntin bar 32 which channel is closed by a snap lock closing bar or strip 35. As shown in FIGS. 5 and 6, the outer muntin bar 31 has a body portion 36 having an upper wall 37 and a lower wall 38 spaced therefrom.

The exterior side of the body portion 36 is generally T-shaped providing upper and lower flanges 39 and 40 to engage or embrace the upper and lower panels 28 and 29 respectively. Spaced outwardly from the flanges 39 and 40 and centrally therebetween is a wall 41 which connects to the outer ends of the flanges 39 and 40 by trim walls 42 and 43 respectively.

At its interior side, the body portion 36 of the outer muntin bar is provided with a socket 44 to interfit with the inner muntin bar 32 as hereinafter explained.

The inner muntin bar 32 has a body portion 45 which defines a channel 46 to receive and house the heads 47 of the screws 33.

The body 45 of the inner frame member has upper and lower flanges 48 and 49 which are adapted to engage or embrace the upper and lower glazing units 28 and 29 respectively.

At its interior side, the inner frame body 45 has a nose portion 50 which is adapted to project into the socket 44 in the body portion of the outer frame 31 when the inner and outer muntin bars are brought together as illustrated in FIG. 6.

Joining the outer ends of the flanges 48 and 49 and the mouth of the channel 46 of the inner muntin bar 32 are trim walls 51 and 52 respectively.

It will be understood that the muntin bars 31 and 32 will extend across from one side to the other of the frames 1 and 2 with the lower and upper panels 29 and 28 sandwiched between the frames 1 and 2 at their sides and at their edges remote from the dividing muntin bar assembly 30 to provide a divided doorlite which can be mounted very easily, quickly and securely simply by screwing the frames 1 and 2 and the muntin bars 31 and 32 together after which all of the screws whose heads are received in the respective frame and muntin bar channels immediately hidden by snapping on the closure frame 6 and the muntin bar closure 35.

The manufacture of the frames 1 and 2 for straight sided door openings can be carried out very simply by extruding lengths of suitable material such as PVC having the desired inner and outer profiles as shown, for example, in FIG. 2, drilling the bodies 14 and 7 with the appropriate screw guide bores on line, then screwing these elongated frame profiles together, then closing the channel 17 of the inner profile member with an extruded length of material having the closure frame profile as shown in FIG. 2.

The assembled profiles are then cut into lengths corresponding to the lengths of the sides of the doorlite opening with the angles of the cuts such that the cut lengths can be assembled to provide the requisite frame configuration. These assembled lengths are then screwed together into complete inner, outer and cover frames ready to be shipped as a package for the particular doorlite opening.

For the usual rectangular doorlite in which a rectangular opening is provided or cut in the door, the screwed together lengths of frame profile are cut at the appropriate points corresponding to the length of the sides of the doorlite opening at 45 degree angles. These four cut pieces are then screwed together into the inner and outer frames and cover frame as shown in FIG. 1 and shipped in this assembled relation.

At the installation cite, the screws 4 are temporarily removed, the outer frame 1 then has its body portion 7 inserted into the doorlite opening from the outer side of the door with the outer frame flange 10 engaging the door around the opening. The glazing unit or panel is then inserted into the outer frame 1 to engage the inner flange 11 of the frame. The inner frame 2 then has its body portion 14 inserted into the door opening from the inner side of the door so that its flange 19 engages the door around the perimeter of the opening and its glazing unit engaging flange 20 engages the glazing unit. The two frames 1 and 2 are then again secured together by the screws 4 and the closure frame 6 snapped into place to conceal the heads of the screws housed within the inner frame channel 17.

Where the doorlite is to be a divided doorlite, the muntin bars 31 and 32 will be employed between the glazing panels as described above.

It will be understood that various details in the appearances of the profiles of the frames 1 and 2 may be made as desired.

It will also be understood that, while the invention is particularly applicable to providing a doorlite system for doorlite openings that have straight sides so that the frame profiles can be extruded, it is applicable to other shapes of doorlite openings where, for instance, the frames can be molded to the appropriate shape.

Although various preferred embodiments of the present invention have been described herein in detail, it will be appreciated by those skilled in the art, that variations may be made thereto without departing from the scope of the appended claims.

The embodiments of the invention in which an exclusive Property or privilege is claimed are defined as follows:

1. A doorlite frame assembly for mounting a doorlite in an opening in a door comprising first and second frames each having a frame body for introduction into the door opening one from one side of the door the other from the opposite side of the door to be secured together within the door opening, said frame bodies having interengaging body registering means extending therearound and further having flanges thereon to embrace the door around the perimeter of the door opening and to retain a doorlite within the door opening.

2. A doorlite frame assembly as claimed in claim 1 further having first and second muntin bars to bridge across said first and second frames to provide a divided doorlite, each of said muntin bars having a body portion to project into the door opening one from one side of the door and the other from the other side of the door to be secured together within the door opening, said muntin bar bodies having flanges on opposite sides thereof to embrace and retain a doorlite on opposite sides thereof.

3. A doorlite frame assembly as claimed in claim 1 or 2 in which the body of one of said first and second frames has a channel therein to receive and house the heads of screws to be used to secure said frame bodies together and a cover for said channel.

4. A doorlite frame assembly as claimed in claim 2 in which the body of one of said frames and the body of one of said muntin bars each are provided with a channel therein to receive and house the heads of screws to be used to secure said frame bodies and said muntin bar bodies together, and covers for said channels.

5. A doorlite frame assembly formed of plastic material for mounting a doorlite in an opening in a door comprising an inner frame and an outer frame each having a frame body for introduction into the door opening one from one side of the door the other from the opposite side of the door and adapted to be screwed together within the door opening, said frame bodies having flanges to embrace the door around the perimeter of the door opening and to retain a doorlite within said opening, said inner frame body having a channel extending around the perimeter thereof for housing the heads of screws to be used to screw said frame bodies together and a cover for said channel.

6. A doorlite frame assembly as claimed in claim 5 in which said frame bodies have interengaging registering means extending continuously therearound.

7. A doorlite frame assembly as claimed in claim 5 or 6 provided with inner and outer muntin bars to bridge across said inner and outer frames to provide a divided doorlite, each of said muntin bar having a body portion for projecting into the door opening one from one side of the door, the other from opposite sides of the door, said muntin bar bodies being adapted to be screwed together and having flanges therein to embrace and retain a doorlite on opposite sides thereof, said inner muntin bar body having a channel therein for housing the heads of screws to be used to secure said muntin bar bodies together, and a cover for said muntin bar channel.

8. A doorlite frame assembly comprising inner and outer frames each having a cross sectional profile comprising a body portion for insertion into an opening into a door, one from one side of the door, the other from the opposite side of the door to lie contiguous to the perimeter of the opening, with means to effect registration of said body portions, each of said body portions having a door embracing flange to embrace the door around the opening and a glazing unit embracing flange to retain a glazing unit within the opening, said inner frame having a screw head receiving channel in said body between its respective flanges, said inner and outer frames being secured together with their body portions in face to face contact by screws driven through said inner frame body portion and into said outer body portion with the heads of said screws housed in said channel and a cover for said channel to hide said screw heads.

9. A doorlite frame assembly as claimed in claim 8 in which said channel and cover are formed to provide a snap connection therebetween.

10. An outer frame for a doorlite france assembly, said outer frame being formed of extruded plastic material, and having a body portion having an outer peripheral wall, an inner peripheral wall spaced from said outer wall, an exterior side and an interior side, said outer wall extending beyond said inner wall at said exterior side and terminating in an outwardly extending door engaging flange, said inner wall at said exterior side having an inwardly extending glazing member retaining flange, a trim wall extending from adjacent the exterior end of said outer side to adjacent the end of said glazing member retaining flange, the interior side of said frame being formed with a continuous formation extending therearound adapted for interengagement with a mating formation of an inner doorlite frame adapted to be connected with a mating inner doorlite frame.

11. A doorlite frame as claimed in claim 10 in which said continuous formation at the interior side of said body portion is a socket having predetermined spaced screw guiding bores drilled therein around the perimeter thereof.

12. An inner doorlite frame member for a doorlite frame assembly formed of extruded plastic material and having a body portion having an outer perimeter wall and an inner perimeter wall spaced from said outer wall, an exterior side and an interior side, said outer and inner walls defining a channel therebetween opening to said exterior side and said interior side being adapted to be connected to a mating outer doorlite frame, an outwardly extending door engaging flange at the exterior side of said outer perimeter wall and an inwardly extending glazing member retaining flange at the interior side of said inner wall, a trim wall joining the exterior end of said inner wall and the end of said glazing member retaining flange, and a cover for covering said channel.
